(19) United States
(12) Patent Application Publication
(10) Pub. No.: US 2010/0028526 A1
(43) Pub. Date: Feb. 4, 2010

(54) THIN FILM COATING METHOD

(76) Inventors: Steve Martin, Saint Sauveur (FR); Pascal Faucherand, Sassenage (FR); Lucie Jodin, Nancy (FR); Jérôme Gavillet, Grennoble (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/516,459

(22) PCT Filed: Nov. 6, 2007
(86) PCT No.: PCT/FR07/01825

§ 371 Date: Oct. 13, 2009

(30) Foreign Application Priority Data
Nov. 28, 2006 (FR) 0610384

(51) Int. Cl. B05D 7/24; B05D 5/08

(52) U.S. Cl. 427/2.24

(57) ABSTRACT

The invention relates to a thin film coating method using a thin film having minimal adhesion in relation to biological species, of the type comprising the deposition of a thin film with —COOH function. The invention is characterised in that the method includes a step involving the vapour phase chemical decomposition of a carbonaceous precursor containing neither a carboxyl group nor a carbonyl group, in the presence of water. The invention is particularly suitable for use in the field of thin films.

The invention relates to a thin film coating method having minimal adherence with respect to biological species.

Implants, catheters, intraocular lenses or more generally any biosystem (biocomponent) require surfaces (non-fouling surfaces) to which biological substances such as proteins, lipids or cells do not adhere.

Indeed, the reactions at a solid-liquid interface are generally complex, multiple and specific to the nature of the species present. In all these cases, the reactions lead to a localized biological disturbance of the receiving medium that is characterized by the formation of an interfacial level between the foreign body (the implant, catheter, intraocular lens) and the receiving medium (the body, the eye). Controlling the activity of this interface layer is necessary for the equilibrium of compatible conditions between the substance and the living organism (biocompatibility).

The constituent materials of various biosystems are generally chosen for their mechanical, optical or else electrical properties but most of the time are not or not very biocompatible.

In order to solve this problem it has been proposed to deposit a thin layer of a biocompatible material, having a thickness of less than 1 μm, onto the biosystem.

The approach commonly adopted to date consists in trying to incorporate a —COOH (carboxylic acid) functionality present in an initial precursor of the final material.

This is because the materials that have a minimal adhesion with respect to biological species in general have a —COOH group.

The deposition thereof may be carried out, as described for example in International Patent Application WO 03/090939, by plasma using a precursor comprising the —COOH group, which may be written in the form X—COOH.

Document WO 03/090939 also describes the use of a precursor comprising a carbonyl group, the —OH functionality being provided by a donor gas such as water.

Thus, in the method described in this document, either the —COOH functionality is already present in the precursor, or the presence of a —C═O carbonyl group in the precursor used is essential since this is the group that will make it possible to form the —COOH functionality, for example by injecting water or methanol into the plasma device, at the same time as the carbonyl-containing precursor.

The plasma technique makes it possible to break some bonds in the X precursor, which will enable the anchoring of material to the desired support.

But the main bond between the X precursor and the —COOH or —C═O group is weak: the plasma must not destroy it. The plasma power is therefore limited.

As a consequence, the materials obtained are no longer crosslinked: they have poor mechanical strength and chemical resistance. In this process there is also a limitation on the choice of precursor and therefore of the final matrix, and therefore on the properties other than the lack of adhesion.

Thus, it is proposed to produce coatings made of polyethylene oxide/polyethylene glycol which is the reference biocompatible material. It may be deposited as a thin film by plasma or by grafting or else by various liquid phase chemical processes.

The problem with these types of treatments lies in the fact that they are not compatible with most of the microelectronic technologies and therefore are not suitable for producing integrated biocomponents due to a non-conforming deposition, and/or a low adhesion and/or the complexity of the method used.

It has been proposed to produce a coating made from a PEO-like material by plasma polymerization. The PEO-like material is a polyethylene oxide having a composition slightly different from the polyethylene oxide obtained by liquid phase synthesis.

But again the major problem encountered is the need to retain the initial functionality (generally the ethylene oxide EO (—CH₂—CH₂—O)ₙ). This constraint makes it necessary, in this case also, to use plasmas of very low power that lead to the production of depositions, admittedly biocompatible depositions, but that once again are not or not very crosslinked.

Furthermore, a method of etching organic materials is known in which water is injected into a plasma (E. J. Tonnis & al. J. Vac. Sci. Technol. A18-2., March/April 2000). Specifically, the H₂O molecule leads to the formation of OH⁻ radicals that are particularly effective for etching organic substances, which is to be avoided in a coating method.

To summarize, the biocompatible thin film deposition processes from the prior art lead to depositions that have numerous disadvantages, among which mention may be made of:
a low mechanical strength;
a low stability over time (ageing);
a low resistance to organic solvents;
the handling and discharge of precursors that are harmful to the environment and dangerous to humans; and
a nature of the matrix imposed by the precursor comprising the —COOH or —C═O functionality.

Although it is today possible to make do with the first four disadvantages, one impassable sticking point remains however, which is the nature of the matrix and therefore the general physical properties of the deposition.

The present invention solves this problem by allowing the in situ functionalization, that is to say functionalization that takes place during the production of the coating, of any type of matrix. It thus becomes possible to choose a material for its properties, for example its optical properties, and to add a non-fouling functionality to it.

Thus, the invention relates to a method of functionalizing a thin film which is in the process of developing with —COOH functional groups for, in particular, the production of a non-fouling surface or a surface having minimal adhesion to the biological substance.

The invention is based on the principle of the vapor phase chemical decomposition of a carbon-based precursor, that comprises neither a —COOH functionality nor a —C═O functionality, in the presence of water vapor.

Thus, the invention proposes a thin film coating method having minimal adherence with respect to biological species of the type comprising the deposition of a thin film having —COOH functional groups, comprising a step of the vapor phase chemical decomposition of a carbon-based precursor that does not comprise a carbonyl group or carboxyl group, in the presence of water.

Said vapor phase chemical decomposition step may be activated by plasma and/or by a supply of heat, and/or by a supply of waves and/or radiation, preferably by plasma.

The chemical decomposition is preferably activated by plasma as an energy carrier. This plasma may, for example, be of the radio frequency, low frequency, ECR (electron cyclic resonance), ICP (inductively coupled plasma), or DBD (dielectric barrier discharge) type.

However, the use of heat, and/or waves and/or radiation, and/or several of these energy sources, optionally in combination with the plasma, is also part of the invention.

In a first preferred embodiment, the carbon-based precursor is a precursor of a hydrophobic material such as a fluorocarbon or an organosilicon compound or mixtures thereof.

Preferably, the precursor of the hydrophobic material is C₄F₈ or C₂F₄ or hexamethyldisiloxane or mixtures thereof.

In a second preferred embodiment, the carbon-based precursor is a precursor of a hydrophilic material such as a hydrocarbon.

Preferably, the precursor of the hydrophilic material is C₂H₂ or C₉H₁₀ or mixtures thereof.

The invention will be better understood and other features and advantages of it will appear more clearly in light of the following description which is given with reference to exemplary embodiments of the methods of the invention and with reference to the figures in which:

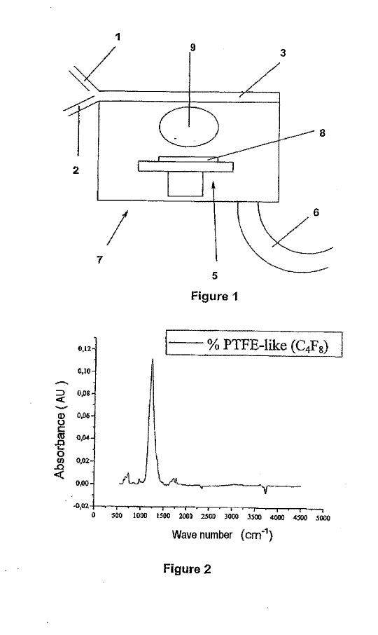

FIG. 1 schematically represents an example of a device for implementing the method of the invention;

FIG. 2 represents the infrared spectrum of a polytetrafluoroethylene-like (PTFE-like) film obtained from C₄F₈ without functionalization;

FIG. 3 represents the infrared spectrum of a PTFE-like film obtained from C₄F₈ according to the method of the invention;

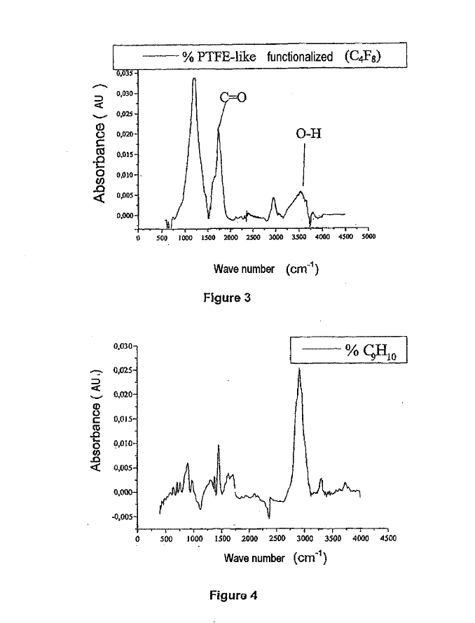

FIG. 4 represents the infrared spectrum of an amorphous carbon (a-CH) film, that is to say a hydrophilic film, without functionalization, obtained from C₉H₁₀;

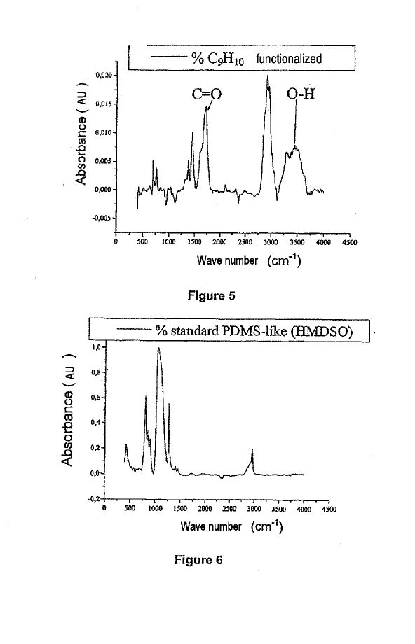

FIG. 5 represents the infrared spectrum of an a-CH film obtained from C₉H₁₀ according to the method of the invention;

FIG. 6 represents the infrared spectrum of a polydimethylsiloxane-like (PDMS-like) film obtained from hexamethyldisiloxane, without functionalization;

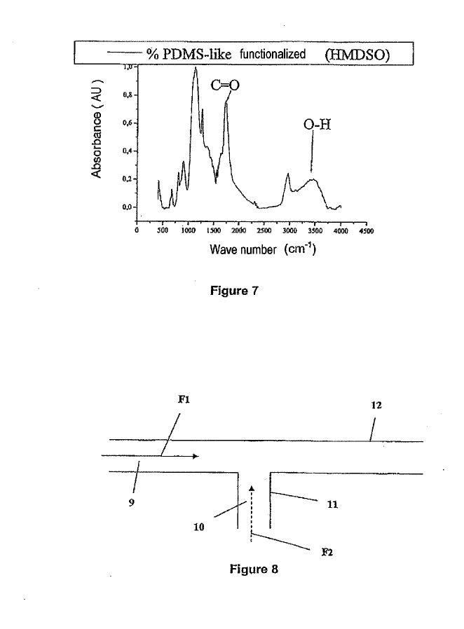

FIG. 7 represents the infrared spectrum of a PDMS-like film obtained from hexamethyldisiloxane according to the method of the invention; and

FIG. 8 is a schematic representation of a passive microfluidic valve according to one embodiment of the invention.

Thus, in the method of the invention, a gas mixture composed of at least one carbon-based precursor gas comprising at least one carbon atom but neither —COOH functionality nor —C═O functionality and water vapor is used.

Of course, several such carbon-based precursors may be used simultaneously.

Preferably, the gas mixture is entrained by a suitable carrier gas such as for example helium, argon or hydrogen or mixtures thereof.

The method of the invention makes it possible to obtain a film made from a material chosen for its properties, for example its mechanical, optical or electrical properties, and to add —COOH functionalities to it, while the film is in the process of developing.

The method of the invention consists in starting the formation of a thin film with a precursor that has neither —COOH functionality nor —C═O functionality, and of creating the bond between the material formed and the —COOH functionality in situ.

It is therefore sufficient for the precursor to contain carbon and for water to be introduced into the chamber. Unexpectedly, it has been discovered that it was possible to manufacture depositions that were strong and of course non-fouling or that had minimal fouling with respect to biological species by the method of the invention which makes it possible to work at higher powers of the plasma, when plasma is used as the energy source.

The precursor is any precursor containing carbon. It may be chosen so as to create a film having a hydrophilic or hydrophobic coating.

By choosing a precursor from a hydrophilic material, a film having a hydrophilic coating will be obtained.

Among the hydrophilic material precursors mention may be made of hydrocarbons.

Preferably, use is made, in the case where it is desired to obtain a hydrophilic coating, of C₂H₂ or C₉H₁₀ or a mixture thereof.

When it is desired to obtain a hydrophobic coating, a hydrophobic material precursor is used, such as a fluorocarbon, preferably C₄F₈ or C₂F₄.

In order to form a hydrophobic film, it is also possible to use an organosilicon compound such as for example hexamethyldisiloxane (HMDSO) as the precursor material.

In other words, the invention allows the deposition of a film having the desired mechanical, electrical and/or optical features, and a minimal adhesion with respect to biological species, in particular on any type of implanted biological system, on the one hand, and on any type of fluidic system for biological applications, on the other hand.

Mention may be made, non-exhaustively, of the treatment of intraocular implants, catheters, the treatment of the channels of microfluidic systems such as “lab-on-Chips” or MEMS (microelectromechanical systems), etc.

Indeed, the reduction in scale gives the surfaces an increasingly high importance and it is therefore necessary to control, as best as possible, their biological activities.

Furthermore, by virtue of the method of the invention it is possible, for example, to make the inside of a channel non-fouling with respect to biological substances.

Specifically, depending on the choice of the initial functionalized material and therefore of the precursor used, the channel could be made hydrophilic or hydrophobic according to choice. This advantage is particularly beneficial in the content of the production of passive valves as will be explained in the examples.

In order to make the invention better understood, several implementation and embodiment examples will now be given.

The implementation and embodiment examples of the invention that are given below are given only by way of illustration and should not in any case be considered as limiting the invention.

The principle of the method for functionalizing thin films in the process of developing with COOH functional groups for the production of surfaces that are non-fouling with respect to biological substances and also the thin film coating method having minimal adhesion with respect to biological species of the invention will be described with reference to FIG. 1.

The invention consists in injecting, into a sealed chamber, denoted by 7 in FIG. 1, kept under vacuum using the vacuum pump (not shown) connected to the duct denoted by 6 in FIG. 1, on the one hand the precursor or precursors of the final materials of the coating, in gaseous form, via the duct denoted by 2 in FIG. 1, and also, on the other hand, water vapor, via the duct denoted by 1 in FIG. 1.

The ducts 1 and 2 are connected to a perforated duct denoted by 3 in FIG. 1 which allows the transport of the precursor or precursors and of the water vapor to the inside of the chamber 7. The sample to be coated, denoted by 8 in FIG. 1, is placed on the sample holder denoted by 5 in FIG. 1, and the precursor or precursors and water are decomposed by plasma in the chemical reaction zone, denoted by 9 in FIG. 1, and the reaction products are deposited on the sample 8.

This method allows the in situ formation, whilst the film is developing, of carboxylic acid and enables it to be incorporated into the layer in the process of developing.

As has already been said, the injection of water vapor into plasmas is generally reserved for etching. This is because the decomposition of the H₂O molecule leads to the formation of OH⁻ radicals that are particularly effective for etching organic substances, which should be avoided in a thin film coating method.

However, owing to the methods of the invention in which the COOH-coating bond is carried out in situ, it is possible to use the water not as an etching agent but as a vector for the functionalization with carboxylic acid (—COOH) functional groups, of layers in the process of developing, as will be shown in the following examples, since the methods of the invention make it possible to use higher plasma powers.

### EXAMPLE 1

In this example, a layer of PTFE-like material functionalized by the method of the invention was deposited onto a silicon substrate. The operating conditions for the deposition and the development of the layer were the following:
precursor: C₄F₈;
plasma power: 300 W;
flow rate of the C₄F₈ precursor: 80 cm³/min;
H₂O flow rate: 10 cm³/min;
time: 1 min;
pressure: 1 mb.

For comparison, a silicon substrate was coated with a layer obtained from the same C₄F₈ precursor, without addition of water, under the same conditions.

The infrared spectrum of the deposition obtained without addition of water, that is to say the unfunctionalized deposition, is represented in FIG. 2.

As can be seen in FIG. 2, the coating obtained is not functionalized by COOH groups, as this spectrum shows only the absorption peaks of the fluorocarbon matrix.

In contrast, the infrared spectrum of the deposition obtained with the method of the invention, that is to say using C₄F₈ and water as precursor, very clearly reveals the presence of COOH groups (C═O at around 1700 cm⁻¹; O—H at around 3500 cm⁻¹).

The property of minimal adhesion with respect to biological species of these two layers was analyzed by labeling of antigen, cell lysate, serum and biopsy proteins with Cy3 and Cy5 fluorophors. The results of this study clearly show that the layer functionalized by the method of the invention has a minimal adhesion with respect to biological species whereas the unfunctionalized layer has a high adhesion.

At the same time, measurements of the contact angles were carried out on the two surfaces. The contact angle for the unfunctionalized surface was 110° and for the functionalized surface was 105°. These results show that the functionalized layer retained the properties of low surface energy of the initial matrix.

This example shows that it is possible to produce a hydrophobic surface having minimal adhesion with respect to biological species.

### EXAMPLE 2

The coating of a silicon substrate with a layer of amorphous carbon was carried out by the method of the invention under the following conditions:
precursor: C₉H₁₀;
plasma power: 100 W;
flow rate of the C₉F₁₀ precursor: 500 cm³/min;
H₂O flow rate: 20 cm³/min;
time: 2 min;
pressure: 1 mb.

Another coating was carried out under the same operating conditions, but in the absence of water.

The infrared spectrum of the deposition obtained without addition of water is represented in FIG. 4. As can be seen in FIG. 4, the layer obtained is not functionalized by —COOH groups whereas, as can be seen in FIG. 5 which represents the layer obtained with the method of the invention, the latter is functionalized.

The contact angle measurements carried out on these two surfaces gave, for the surface obtained according to the method of the invention, a contact angle of 32° and, for the unfunctionalized surface, a contact angle of 28°. These results show that the layer obtained according to the method of the invention has retained the high surface energy properties of the initial matrix. It is thus possible to produce a hydrophilic surface having minimal adhesion with respect to biological species.

### EXAMPLE 3

A layer of PDMS-like material was deposited on a silicon substrate by the method of the invention. The precursor used was hexamethyldisiloxane (HMDSO):
plasma power: 100 W;
flow rate of the HMDSO precursor: 60 cm³/min;
H₂O flow rate: 10 cm³/min;
time: 2 min;
pressure: 1 mb.

A layer was deposited in the same manner on a silicon substrate. However, in this case, water was not injected into the plasma chamber.

The infrared spectrum of the layer obtained by the method without injection of water is represented in FIG. 6. It clearly shows that the layer has not been functionalized by —COOH groups.

On the other hand, the infrared spectrum represented in FIG. 7, obtained over the layer obtained by the method according to the invention, reveals the presence of these COOH groups.

Thus, all sorts of materials can be functionalized with carboxylic acid groups having the properties of no adhesion or of low adhesion with respect to biological matter.

### EXAMPLE 4

The invention allows the deposition of a film having minimal adhesion with respect to biological species on all types of implanted biological systems on the one hand, and fluidic systems for biological applications on the other hand.

For example, and as represented in FIG. 8, the channels of microfluidic system(s) such as “lab-on-Chips” or MEMS may be coated with a layer of material to which biological matter does not adhere, but also it could be chosen to make this layer hydrophilic or hydrophobic.

FIG. 8 represents a passive microfluidic valve, which comprises a first channel denoted by 9 and a second channel denoted by 10 in FIG. 8. The wall, denoted by 12 in FIG. 8, of the channel 9 is coated with a hydrophilic deposition having a —COOH functionality whereas the wall, denoted by 11 in FIG. 8, of the channel 10 is coated with a hydrophobic material having a —COOH functionality.

The hydrophobic material coating of the wall 11 of the channel 10 makes it possible to prevent the fluid flowing in the channel 9 in the direction of the arrow denoted by F1 in FIG. 8 from going up the channel 10, in which the fluid flows in the direction of the arrow denoted by F2 in FIG. 8.

1. A thin film coating method having minimal adherence with respect to biological species of the type comprising the deposition of a thin film having —COOH functional groups, characterized in that it comprises a step of the vapor phase chemical decomposition of a carbon-based precursor that does not comprise a carbonyl group or carboxyl group, in the presence of water.

2. The method as claimed in claim 1, characterized in that said vapor phase chemical decomposition step is activated by plasma and/or by a supply of heat, and/or by a supply of waves and/or radiation.

3. The method as claimed in claim 1, characterized in that the carbon-based precursor is a precursor of a hydrophobic material such as a fluorocarbon or an organosilicon compound or mixtures thereof.

4. The method as claimed in claim 3, characterized in that the precursor of the hydrophobic material is C₄F₈ or C₂F₄ or hexamethyldisiloxane or mixtures thereof.

5. The method as claimed in claim 1, characterized in that the carbon-based precursor is a precursor of a hydrophilic material such as a hydrocarbon.

6. The method as claimed in claim 5, characterized in that the precursor of the hydrophilic material is C₂H₂ or C₉H₁₀ or mixtures thereof.
